(19) United States
(12) Patent Application Publication
(10) Pub. No.: US 2025/0202049 A1
(43) Pub. Date: Jun. 19, 2025

(54) SEPARATOR FOR ELECTROCHEMICAL DEVICE, MATERIAL AND ELECTROCHEMICAL DEVICE

(71) Applicant: Sumitomo Chemical Company, Limited, Tokyo (JP)

(72) Inventors: Masumi YAMASHITA, Niihama-shi (JP); Koki Suma, Niihama-shi (JP)

(21) Appl. No.: 18/977,297

(22) Filed: Dec. 11, 2024

(30) Foreign Application Priority Data
Dec. 13, 2023 (JP) 2023-210502

(51) Int. Cl. H01M 50/423; H01G 11/52; H01M 10/058; H01M 10/42; H01M 50/417; H01M 50/449; H01M 50/489

(52) U.S. Cl. CPC H01M 50/423; H01G 11/52; H01M 10/058; H01M 10/4235; H01M 50/417; H01M 50/449; H01M 50/489

(57) ABSTRACT

Provided is a separator for an electrochemical device which separator improves a cycle characteristic, especially a high-rate cycle characteristic. A separator in accordance with the present disclosure includes a polyolefin porous substrate and a porous layer formed on the polyolefin porous substrate, and, in a case where a cycle of applying a pressure of 70 MPa to a surface of the separator for 60 seconds, carrying out unloading, and then letting the separator stand for 60 seconds is repeated twice, a product of a recovery rate of the separator with respect to a compression amount in a first cycle and a recovery rate of the separator with respect to a compression amount in a second cycle is not less than 850%².

This Nonprovisional application claims priority under 35 U.S.C. § 119 on Patent Application No. 2023-210502 filed in Japan on Dec. 13, 2023, the entire contents of which are hereby incorporated by reference.

### TECHNICAL FIELD

The present invention relates to a separator for an electrochemical device (hereinafter referred to as a “separator”), a material for an electrochemical device (hereinafter referred to as a “material”), and an electrochemical device.

### BACKGROUND ART

Electrochemical devices, e.g., nonaqueous electrolyte secondary batteries, particularly lithium ion secondary batteries, have a high energy density, and are therefore widely used as batteries for personal computers, mobile telephones, portable information terminals, cars, and the like.

As a material of such a nonaqueous electrolyte secondary battery, a separator having excellent heat resistance is under development. For example, as in Patent Literature 1, a separator is known in which a heat-resistant layer containing an aramid resin and inorganic particles is formed on a porous substrate.

### CITATION LIST

### Patent Literature

### [Patent Literature 1]

International Publication No. WO 2019/176421

### SUMMARY OF INVENTION

### Technical Problem

However, an electrochemical device including the conventional separator such as the separator disclosed in Patent Literature 1 has room for improvement in terms of a cycle characteristic, especially a high-rate cycle characteristic. An aspect of the present invention has an object to provide a separator that enables improvement of a cycle characteristic of an electrochemical device, especially a high-rate cycle characteristic of an electrochemical device.

### Solution to Problem

The inventors of the present invention conducted diligent studies and consequently conceived of the present invention by finding that the above-described object is achieved by a separator, in a case where a cycle consisting of applying a specific pressure and then carrying out unloading is repeated twice, having a high product of a recovery rate of the separator with respect to a compression amount in a first cycle and a recovery rate of the separator with respect to a compression amount in a second cycle.

A separator in accordance with an aspect of the present invention includes a polyolefin porous substrate and a porous layer formed on the polyolefin porous substrate, and, in a case where a cycle consisting of applying a pressure of 70 MPa to a surface of the separator for 60 seconds, carrying out unloading, and then letting the separator stand for 60 seconds is repeated twice, a product of a recovery rate [%] of the separator with respect to a compression amount in a first cycle and a recovery rate [%] of the separator with respect to a compression amount in a second cycle is not less than 850%².

### Advantageous Effects of Invention

An aspect of the present invention makes it possible to provide a separator that enables improvement of a cycle characteristic of an electrochemical device, especially a high-rate cycle characteristic of an electrochemical device.

### DESCRIPTION OF EMBODIMENTS

### [1. Separator]

A separator in accordance with an embodiment of the present invention includes a polyolefin porous substrate and a porous layer formed on the polyolefin porous substrate, and, in a case where a cycle consisting of applying a pressure of 70 MPa to a surface of the separator for 60 seconds, carrying out unloading, and then letting the separator stand for 60 seconds is repeated twice, a product of a recovery rate [%] of the separator with respect to a compression amount in a first cycle and a recovery rate [%] of the separator with respect to a compression amount in a second cycle is not less than 850%².

Hereinafter, the “separator in accordance with an embodiment of the present invention” is also referred to simply as a “separator”. The “polyolefin porous substrate” included in the separator is also referred to simply as a “porous substrate”. In a case where a cycle consisting of applying a pressure of 70 MPa to a surface of the separator for 60 seconds, carrying out unloading, and then letting the separator stand for 60 seconds is repeated twice, a recovery rate [%] with respect to a compression amount in the first cycle is referred to as “first recovery rate”, and a recovery rate [%] with respect to a compression amount in the second cycle is referred to as “second recovery rate”. A product of the first recovery rate and the second recovery rate is referred to as “recovery rate product”.

In an embodiment of the present invention, “a cycle consisting of applying a pressure of 70 MPa to a surface of the separator for 60 seconds, carrying out unloading, and then letting the separator stand for 60 seconds is repeated twice” means that the following operations (a) to (h) are carried out.
(a) The separator is subjected to an operation of applying a load of 70 MPa to the surface of the separator from above in a direction perpendicular to the surface of the separator.
(b) The separator having been subjected to the operation (a) is subjected to an operation of maintaining the load of 70 MPa for 60 seconds.
(c) The separator having been subjected to the operation (b) is subjected to an operation of reducing the load to approximately 0 MPa.
(d) The separator having been subjected to the operation (c) is subjected to an operation of maintaining the load of approximately 0 MPa for 60 seconds.
(e) The separator having been subjected to the operation (d) is subjected to an operation that is identical to the operation (a).
(f) The separator having been subjected to the operation (e) is subjected to an operation that is identical to the operation (b).
(g) The separator having been subjected to the operation (f) is subjected to an operation that is identical to the operation (c).
(h) The separator having been subjected to the operation (g) is subjected to an operation that is identical to the operation (d).

A specific method for carrying out the operations (a) to (h) is not particularly limited and includes, for example, a method disclosed in Examples. Note that the operations (a) to (h) are ordinarily carried out under the conditions of room temperature (approximately 25° C.).

The “surface” in the operation (a) means a porous layer-side surface of the separator. Note that, in a case where the porous layer is formed on both surfaces of the porous substrate in the separator, the “surface” may be either of porous layer-side surfaces of the separator.

A method for applying a load in the operation (a) is not particularly limited and includes, for example, a method of pressing a flat indenter into a surface of the separator and a method of pressing the separator from a surface side of the separator with use of a pressing machine.

In the operation (b), a method for maintaining the load is not particularly limited. In a case where, in the operation (a), the application of the load is carried out by pressing the flat indenter into the surface of the separator, the method for maintaining the load in the operation (b) includes, for example, a method of fixing (holding) the position of the flat indenter as it is in a state in which the flat indenter is pressed into the surface of the separator. Alternatively, in a case where, in the operation (a), the application of the load is carried out by pressing the separator with use of the pressing machine, the method for maintaining the load in the operation (b) includes, for example, a method of continuing the pressing while maintaining the load. Specifically, the method of continuing the pressing while maintaining the load is a method in which the pressing is carried out in the operations in the section [1. Separator] under the conditions of a press pressure of 70 MPa and a press time of 60 seconds.

In the operation (c), a method for reducing the load is not particularly limited. In a case where, in the operation (a), the application of the load is carried out by pressing the flat indenter into the surface of the separator, the method for reducing the load includes, for example, a method of lifting the flat indenter from the surface of the separator. Alternatively, in a case where, in the operation (a), the application of the load is carried out by pressing the separator with use of the pressing machine, the method for reducing the load includes, for example, a method of stopping (suspending) the pressing to release the separator from its loaded state.

The expression “approximately 0 MPa” in the operation (c) means a pressure of 0 MPa or a pressure that can be approximated to 0 MPa. A precise value of the pressure that can be approximated to 0 MPa can be, for example, 1 mN.

In the operation (d), a method for maintaining the load is not particularly limited. In a case where, in the operation (c), the reduction of the load is carried out by lifting the flat indenter from the surface of the separator, the method for maintaining the load in the operation (d) includes, for example, a method of fixing the position of the flat indenter as it is in a state in which the flat indenter is lifted from the surface of the separator. Alternatively, in a case where, in the operation (c), the reduction of the load is carried out by suspending the pressing, the method for maintaining the load in the operation (d) includes, for example, a method of continuing the suspension of the pressing.

Here, a displacement amount of the indenter during a time from the start of the operation (a) to the end of the operation (b) is regarded as a compression amount in the first cycle. Hereinafter, the “compression amount in the first cycle” is referred to as “first compression amount”. In addition, after the operation (b) is carried out, a displacement amount of the indenter during a time from the start of the operation (c) to the end of the operation (d) is regarded as a recovery amount in the first cycle. Hereinafter, the “recovery amount in the first cycle” is referred to as “first recovery amount”. With use of the first compression amount and the first recovery amount, the first recovery rate is calculated in accordance with the following formula (1):

$$First recovery rate [ \% ] = ( first recovery amount [ μm ] / first compression amount [ μm ] ) \times 100 \qquad ( 1 )$$

In addition, after the operation (d) is carried out, a displacement amount of the indenter during a time from the start of the operation (e) to the end of the operation (f) is regarded as a compression amount in the second cycle. Hereinafter, the “compression amount in the second cycle” is referred to as “second compression amount”. In addition, after the operation (f) is carried out, a displacement amount of the indenter during a time from the start of the operation (g) to the end of the operation (h) is regarded as a recovery amount in the second cycle. Hereinafter, the “recovery amount in the second cycle” is referred to as “second recovery amount”. With use of the second compression amount and the second recovery amount, the second recovery rate is calculated in accordance with the following formula (2):

$$Second recovery rate [ \% ] = ( second recovery amount [ μm ] / second compression amount [ μm ] ) \times 100 \qquad ( 2 )$$

Further, with use of the first recovery rate and the second recovery rate, the recovery rate product is calculated in accordance with the following formula (3):

$$Recovery rate product [ {\%}^{2} ] = ( first recovery rate [ \% ] ) \times ( second recovery rate [ \% ] ) \qquad ( 3 )$$

Note that the thickness of the separator as used for calculating the first compression amount, the first recovery amount, the second compression amount, and the second recovery amount means a thickness of a portion of the separator to which the load is applied. For example, in a case where the application of the load is carried out by pressing the flat indenter into the surface of the separator, the portion of the separator to which the load is applied is a portion at which the flat indenter is pressed. In a case where the application of the load is carried out by pressing the separator with use of the pressing machine, the portion of the separator to which the load is applied is a portion at which the separator is directly pressed.

Repeating a cycle of pressure application and unloading with respect to the conventional separator a plurality of times deforms an internal structure of the conventional separator. Hereinafter, the “cycle of pressure application and unloading” is also referred to as “pressure application-unloading cycle”. It is considered that the deformation of the internal structure of the conventional separator leads to incomplete recovery of the shape of the conventional separator at the unloading in the pressure application-unloading cycle and greatly reduces a recovery rate with respect to the compression amount in the remainder of the pressure application-unloading cycle, thus resulting in deterioration in electrical property of the conventional separator. Hereinafter, the “recovery rate with respect to the compression amount” is also referred to simply as “recovery rate”. In contrast, in the case of a separator in accordance with an embodiment of the present invention, the recovery rate product is as high as not less than 850%². This reflects the fact that both the first recovery rate and the second recovery rate are high. From this, it can be understood that the deformation of the internal structure of the separator in accordance with an embodiment of the present invention by the pressure application is small in both the first cycle and the second cycle. Thus, the separator in accordance with an embodiment of the present invention has a property of being less likely to undergo deformation of an internal structure by the application of pressure. Therefore, in the case of the separator in accordance with an embodiment of the present invention, it is considered that, in a case where the pressure application-unloading cycle is repeated a plurality of times, the degree of reduction in recovery rate with respect to a compression amount in each pressure application-unloading cycle becomes low with each passing pressure application-unloading cycle. In other words, it is considered that, in a case where the pressure application-unloading cycle is repeated three or more times, the separator in accordance with an embodiment of the present invention has high recovery rates in the first and second pressure application-unloading cycles and also has high recovery rates in the third and subsequent pressure application-unloading cycles.

Here, in an electrochemical device, an electrode included in the electrochemical device expands and shrinks when a charge-discharge cycle is carried out. When the electrode repeatedly expands and shrinks in the electrochemical device, the pressure application-unloading cycle repeatedly occurs with respect to a separator included in the electrochemical device.

In an electrochemical device, in a case where a separator insufficiently conforms to repeated expansion and shrinkage of the electrode which occur when a charge-discharge cycle is repeated, there is a possibility that a gap which occurs between the electrode and the separator increases the resistance of the electrochemical device, and a cycle characteristic of the electrochemical device thus decreases. In addition, in a case where the charge-discharge cycle is carried out at a high rate, there is a possibility that the decrease in cycle characteristic of an electrochemical device due to the above-described increase in resistance becomes more significant.

In contrast, a separator in accordance with an embodiment of the present invention, when a charge-discharge cycle is repeatedly carried out in an electrochemical device including the separator, has a high recovery rate with respect to compression caused by electrode expansion and shrinkage which occur during arbitrary charge and discharge in repeated charge-discharge cycles. Furthermore, the above-described separator, which has a high recovery rate, is less likely to undergo plastic deformation in the arbitrary charge-discharge cycle and is easily deformed in response to external force applied subsequently. Thus, the above-described separator easily conforms to electrode expansion and shrinkage which occur due to a charge-discharge cycle(s) subsequent to the arbitrary charge-discharge cycle.

As described above, the above-described separator can sufficiently conform to repetition of the electrode expansion and shrinkage. Thus, the above-described separator makes it possible to prevent the above-described decrease in cycle characteristic that can occur when a charge-discharge cycle, especially a high-rate charge and discharge cycle, is repeated in an electrochemical device including the above-described separator. Thus, the above-described separator makes it possible to improve a cycle characteristic of an electrochemical device including the above-described separator, especially a high-rate cycle characteristic of an electrochemical device including the above-described separator.

From the viewpoint of the above-described improvement of a cycle characteristic of the electrochemical device, especially the above-described improvement of a high-rate cycle characteristic of the electrochemical device, the recovery rate product preferably has a high value. Specifically, a lower limit of the recovery rate product is preferably not less than 850%², more preferably not less than 900%², and still more preferably not less than 910%². Note that an upper limit of the recovery rate product is not more than 10000%² since both an upper limit of the first recovery rate and an upper limit of the second recovery rate are 100% as described later.

From the viewpoint of controlling the recovery rate product to a high value and improving a cycle characteristic of the electrochemical device, especially a high-rate cycle characteristic of the electrochemical device, the first recovery rate and the second recovery rate each preferably have a high value. Specifically, a lower limit of the first recovery rate is preferably not less than 10%, more preferably not less than 11%, and still more preferably not less than 11.5%. Further, a lower limit of the second recovery rate is preferably not less than 75%, more preferably not less than 76%, and still more preferably not less than 77%. Note that both an upper limit of the first recovery rate and an upper limit of the second recovery rate are 100%.

Further, in a case where the first compression amount and the second compression amount are large, the above-described separator is easily deformed in accordance with external force and has more excellent conformability to the electrode expansion. As a result, it is possible to further improve a cycle characteristic of an electrochemical device, especially a high-rate cycle characteristic of an electrochemical device. From the above-described viewpoint, a ratio [%] of the first compression amount to the thickness of the separator before compression in the first cycle (hereinafter referred to as “first compressibility”) is preferably not less than 30%, and more preferably not less than 35%. Further, a ratio [%] of the second compression amount to the thickness of the separator after the first cycle and before compression in the second cycle (hereinafter referred to as “second compressibility”) is preferably not less than 5%, and more preferably not less than 7%.

In a case where the first compression amount and the second compression amount are small, the above-described separator is more excellent in terms of its strength. From the above-described viewpoint, the first compressibility [%] is preferably not more than 70%, and more preferably not more than 65%. Further, the second compressibility [%] is preferably not more than 30%, and more preferably not more than 20%.

The separator includes a polyolefin porous substrate and a porous layer formed on the polyolefin porous substrate. That is, the separator is a separator in which the porous layer and the polyolefin porous substrate are formed on top of each other. The porous layer can be formed on one surface of the polyolefin porous substrate or on both surfaces of the polyolefin porous substrate.

The separator may be made of only the porous layer and the porous substrate. Alternatively, as described later, in the separator, a layer that is different from the porous layer and the porous substrate may be formed on at least one layer selected from the group consisting of the porous layer and the porous substrate. As a material included in the electrochemical device, the porous layer can be provided between the porous substrate and at least one of a positive electrode and a negative electrode. The porous layer may be provided between the porous substrate and at least one of the positive electrode and the negative electrode in a manner so as to be in contact with the porous substrate and the at least one of the positive electrode and the negative electrode. The number of porous layer(s) provided between the porous substrate and at least one of the positive electrode and the negative electrode may be one, two, or more. The porous layer is preferably an insulating layer.

The porous layer ordinarily contains a resin. The resin is not limited and is, for example, a nitrogen-containing aromatic resin. A nitrogen-containing aromatic resin means an aromatic resin containing a nitrogen atom. An aromatic resin means a resin containing a structural unit having at least an aromatic group.

Examples of the nitrogen-containing aromatic resin include aromatic polyamides such as a wholly aromatic polyamide (aramid resin) and a semi-aromatic polyamide, aromatic polyimides, aromatic polyamide imides, polybenzimidazoles, aromatic polyurethanes, and melamine resins. In particular, the nitrogen-containing aromatic resin preferably includes an aramid resin.

Examples of the aramid resin include para-aramids and meta-aramids. Among these, para-aramids are more preferable. Examples of the para-aramids include para-aramids each having a para-oriented structure or a quasi-para-oriented structure, such as poly(paraphenylene terephthalamide), poly(parabenzamide), poly(4,4′-benzanilide terephthalamide), poly(paraphenylene-4,4′-biphenylene dicarboxylic acid amide), poly(paraphenylene-2,6-naphthalene dicarboxylic acid amide), poly(2-chloro-paraphenylene terephthalamide), a paraphenylene terephthalamide/2,6-dichloroparaphenylene terephthalamide copolymer, poly(4,4′-diphenylsulfonyl terephthalamide), and a paraphenylene terephthalamide/4,4′-diphenylsulfonyl terephthalamide copolymer. Examples of the meta-aramids include poly(metaphenylene terephthalamide), poly(metaphenylene isophthalamide), poly(metabenzamide), poly(metaphenylene-4,4′-biphenylene dicarboxylic acid amide), and poly(metaphenylene-2,6-naphthalene dicarboxylic acid amide). Poly(metaphenylene isophthalamide) is also referred to as poly [N,N′-(1,3-phenylene) isophthalamide].

The resin is not particularly limited and is preferably two or more resins having different deposition properties during forming of the porous layer. Note here that the two or more resins having different deposition properties means two or more resins having different degrees of solubility in a solvent in a coating solution that is used to form the porous layer. The coating solution is a liquid obtained by dissolving and/or dispersing, in the solvent, a constituent material of the porous layer containing the resin. The two or more resins having different deposition properties with respect to a solvent in which the resin is dissolved preferably include, for example, two or more nitrogen-containing aromatic resins having different deposition properties. As the two or more resins having different deposition properties, it is preferable to combine resins having different structures, such as a resin having a rigid structure and a resin having flexibility. For example, poly(paraphenylene terephthalamide), poly(2-chloro-paraphenylene terephthalamide), poly(parabenzamide), and poly(4,4′-benzanilide terephthalamide) have a rigid structure. In contrast, poly(4,4′-diphenylsulfonyl terephthalamide), a paraphenylene terephthalamide/4,4′-diphenylsulfonyl terephthalamide copolymer, and a meta-aramid have flexibility. Note, however, that a combination of the two or more resins having different deposition properties is not limited to these combinations. The combination of the two or more resins having different deposition properties may be, for example, a combination of resins having relatively close structures, such as a combination of poly(paraphenylene terephthalamide) and poly(2-chloro-paraphenylene terephthalamide).

A proportion of a nitrogen-containing aromatic resin in 100% by weight of a resin contained in the porous layer is preferably more than 50% by weight, more preferably not less than 70% by weight, and still more preferably not less than 90% by weight. The proportion of the nitrogen-containing aromatic resin in 100% by weight of the resin contained in the porous layer may be not more than 100% by weight, or may be less than 100% by weight. The resin contained in the porous layer particularly preferably consists only of a nitrogen-containing aromatic resin.

The porous layer may contain a nitrogen-containing aromatic resin and a resin other than the nitrogen-containing aromatic resin. A proportion of the resin other than the nitrogen-containing aromatic resin in 100% by weight of the resin contained in the porous layer is preferably less than 50% by weight, more preferably not more than 30% by weight, and still more preferably not more than 10% by weight. The proportion of the resin other than the nitrogen-containing aromatic resin in 100% by weight of the resin contained in the porous layer may be not less than 0% by weight, or may be more than 0% by weight.

Examples of the resin other than the nitrogen-containing aromatic resin include polyolefin-based resins; (meth)acrylate-based resins; fluorine-containing resins; polyester-based resins; rubbers; resins each having a melting point or a glass transition temperature of not lower than 180° C.; water-soluble polymers; polycarbonates; and polyacetals. In an embodiment, the resin contained in the porous layer can be a resin that is not a polyester-based resin.

Examples of the polyester-based resins include aromatic polyesters such as a polyarylate and liquid crystal polyesters.

Examples of the rubbers include a styrene-butadiene copolymer and a hydride thereof, a methacrylic acid ester copolymer, an acrylonitrile-acrylic acid ester copolymer, a styrene-acrylic acid ester copolymer, ethylene propylene rubber, and polyvinyl acetate.

Examples of the fluorine-containing resins include polyvinylidene fluoride (PVdF), polytetrafluoroethylene, a vinylidene fluoride-hexafluoropropylene copolymer, a tetrafluoroethylene-hexafluoropropylene copolymer, a tetrafluoroethylene-perfluoroalkylvinyl ether copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer. Particular examples of the fluorine-containing resins include fluorine-containing rubber having a glass transition temperature of not higher than 23° C.

Examples of the resins each having a melting point or a glass transition temperature of not lower than 180° C. include polyphenylene ether, polysulfone, polyether sulfone, polyphenylene sulfide, polyetherimide, polyamide imide, polyether amide, and polyether ether ketone.

Examples of the water-soluble polymers include polyvinyl alcohol, polyethylene glycol, cellulose ether, sodium alginate, polyacrylic acid, polyacrylamide, and polymethacrylic acid.

The porous layer can be a heat-resistant layer. The heat-resistant layer means a layer having a higher melting temperature than a substrate. The resin contained in the porous layer can be a resin having heat resistance. The resin having heat resistance can be a resin having a higher melting point or glass transition temperature than a resin constituting the substrate. The resin contained in the porous layer is preferably a resin that is insoluble in an electrolyte of the electrochemical device and that is electrochemically stable when the electrochemical device is in normal use.

The porous layer can contain a filler. The filler can be an inorganic filler or an organic filler. The filler is preferably a filler made of an inorganic oxide such as silica, calcium oxide, magnesium oxide, titanium oxide, alumina, mica, zeolite, aluminum hydroxide, or boehmite, more preferably a filler made of calcium oxide, magnesium oxide, or alumina, and still more preferably a filler made of alumina.

A filler content in 100% by weight of the porous layer is preferably not less than 0% by weight and less than 20% by weight, more preferably 0% by weight to 15% by weight, still more preferably 0% by weight to 10% by weight, and particularly preferably 0% by weight to 5% by weight. A filler content of 0% by weight means that the porous layer does not contain the filler. In order to ensure ion permeability, the filler content in 100% by weight of the porous layer may be more than 0% by weight, or may be not less than 1% by weight.

The filler has an average particle diameter of preferably not more than 1 μm, more preferably not more than 800 nm, still more preferably not more than 500 nm, still more preferably not more than 100 nm, and still more preferably not more than 50 nm. The average particle diameter of the filler has a lower limit that is not particularly limited and that can be, for example, 5 nm. Note here that the average particle diameter of the filler is an average value of sphere equivalent particle diameters of 50 particles of the filler. Further, the sphere equivalent particle diameters of the filler are values obtained by actual measurement with use of a transmission electron microscope. The following is a specific example of a measurement method.
1. An image of the filler is captured by using a transmission electron microscope (TEM; JEOL Ltd., transmission electron microscope JEM-2100F) at an acceleration voltage of 200 kV and at a magnification ratio of 10,000 times with use of a Gatan Imaging Filter.
2. In the image thus obtained, an outline of a particle is traced by using image analysis software (ImageJ) and a sphere equivalent particle diameter of a filler particle (primary particle) is measured.
3. The above measurement is carried out for 50 filler particles that have been randomly extracted. An arithmetic average of sphere equivalent particle diameters of the 50 filler particles is regarded as the average particle diameter of the filler.

In order to ensure adhesion of the porous layer to an electrode and a high energy density, the porous layer has a thickness per layer of preferably 0.15 μm to 5 μm, more preferably 0.25 μm to 5 μm, and still more preferably 0.35 μm to 3 μm. The porous layer having a thickness per layer of not less than 0.15 μm (i) makes it possible to sufficiently prevent or reduce an internal short circuit which might occur due to, for example, breakage of the electrochemical device and (ii) allows the porous layer to retain an electrolyte in an adequate amount. Meanwhile, in a case where the porous layer has a thickness per layer of not more than 5 μm, in the electrochemical device, it is possible to minimize metal ion permeability resistance, and thus it is possible to minimize a decrease in rate characteristic and in cycle characteristic. Further, in a case where the porous layer has a thickness per layer of not more than 5 μm, it is also possible to minimize an increase in distance between the positive electrode and the negative electrode. This makes it possible to minimize a reduction in internal volume efficiency of the electrochemical device.

A weight per unit area of the porous layer can be determined as appropriate in view of the strength, thickness, weight, and handleability of the porous layer. The porous layer has a weight per unit area per layer of preferably 0.15 g/m² to 10 g/m², and more preferably 0.25 g/m² to 5 g/m². The porous layer having a weight per unit area in the above numerical range allows the electrochemical device to have a higher weight energy density and a higher volume energy density.

The porous layer has a porosity of preferably 20% by volume to 90% by volume, and more preferably 30% by volume to 80% by volume, in order to achieve sufficient ion permeability. Pores of the porous layer have a diameter of preferably not more than 1.0 μm, and more preferably not more than 0.5 μm. In a case where the pores have such a diameter, the electrochemical device can achieve sufficient ion permeability.

The polyolefin porous substrate means a porous substrate that contains a polyolefin-based resin as a main component. The phrase “contain a polyolefin-based resin as a main component” means that the polyolefin-based resin is contained, in the porous substrate, at a proportion of not less than 50% by weight, preferably not less than 90% by weight, and more preferably not less than 95% by weight with respect to all materials that constitute the porous substrate. The porous substrate can be a polyolefin porous film.

The polyolefin-based resin more preferably contains a high molecular weight component having a weight-average molecular weight of 5×10⁵ to 15×10⁶. In particular, the polyolefin-based resin that contains a high molecular weight component having a weight-average molecular weight of not less than 1,000,000 is more preferable because such a polyolefin-based resin allows a resulting separator to have increased strength.

The polyolefin-based resin is exemplified by, but not particularly limited to, thermoplastic resins each obtained by polymerizing a monomer(s) such as ethylene, propylene, 1-butene, 4-methyl-1-pentene, 1-hexene, and/or the like, such as homopolymers and copolymers. Examples of the homopolymers include polyethylene, polypropylene, and polybutene. Examples of the copolymers include an ethylene-propylene copolymer.

Among the above examples of polyolefin-based resins, polyethylene is more preferable because polyethylene makes it possible to prevent a flow of an excessively large electric current to a separator at a lower temperature. Note that preventing the flow of an excessively large electric current is also referred to as “shutdown”. Examples of the polyethylene include low-density polyethylene, high-density polyethylene, linear polyethylene (ethylene-α-olefin copolymer), and ultra-high molecular weight polyethylene having a weight-average molecular weight of not less than 1,000,000. Among these examples, ultra-high molecular weight polyethylene having a weight-average molecular weight of not less than 1,000,000 is still more preferable.

The porous substrate has a thickness of preferably 4 μm to 40 μm, and more preferably 5 μm to 20 μm. The porous substrate having a thickness of not less than 4 μm makes it possible to sufficiently prevent an internal short circuit in the electrochemical device. Meanwhile, the porous substrate having a thickness of not more than 40 μm makes it possible to prevent an increase in size of the electrochemical device.

A weight per unit area of the porous substrate can be determined as appropriate in view of the strength, thickness, weight, and handleability of the porous substrate. Note, however, that the weight per unit area is preferably 4 g/m² to 20 g/m², more preferably 4 g/m² to 12 g/m², and still more preferably 5 g/m² to 10 g/m², so as to allow the electrochemical device to have a higher weight energy density and a higher volume energy density.

The porous substrate has therein many pores connected to one another. This allows a gas and a liquid to pass through the porous substrate from one side to the other side. The porous substrate has an air permeability of preferably 30 s/100 mL to 500 s/100 mL, and more preferably 50 s/100 mL to 300 s/100 mL. The porous substrate having the above air permeability can have sufficient ion permeability. The air permeability represents a value as measured in conformity with JIS P8117 with use of an Oken-type air permeability tester.

The porous substrate has a porosity of preferably 20% by volume to 80% by volume, and more preferably 30% by volume to 75% by volume, so as to (i) retain a larger amount of an electrolyte and (ii) obtain the function of reliably preventing a flow of an excessively large electric current at a lower temperature. In order to achieve sufficient ion permeability and prevent particles from entering the positive electrode and/or the negative electrode, the porous substrate has pores each having a pore diameter of preferably not more than 0.3 μm, and more preferably not more than 0.14 μm.

The separator has a thickness of preferably 5.5 μm to 45 μm, and more preferably 6 μm to 25 μm. The separator having a thickness of not less than 5.5 μm makes it possible to sufficiently prevent an internal short circuit in the electrochemical device. Meanwhile, the separator having a thickness of not more than 45 μm makes it possible to prevent an increase in size of the electrochemical device.

The separator has an air permeability of preferably 30 s/100 mL to 1,000 s/100 mL, more preferably 50 s/100 mL to 800 s/100 mL, and still more preferably 70 s/100 mL to 500 s/100 mL. The separator having the above air permeability can achieve sufficient ion permeability in the electrochemical device. The air permeability represents a value as measured in conformity with JIS P8117 with use of an Oken-type air permeability tester.

The separator may include, as necessary, another functional layer different from the above-described porous substrate and the above-described porous layer (e.g., heat-resistant layer), provided that the object of the present invention is not prevented from being attained. Examples of the another functional layer include known porous layers such as an adhesive layer and a protective layer.

The another functional layer can be provided on one surface of the separator or on both surfaces of the separator. In a case where the separator includes the above-described porous layer on both surfaces of the porous substrate, the another functional layer may be provided on the porous layer on both surfaces of the separator, or may be provided on the porous layer on one surface of the separator. In a case where the separator includes the above-described porous layer only on one surface of the porous substrate, the another functional layer may be provided on the porous layer, or may be provided on a surface of the porous substrate on which surface the porous layer is not provided. The another functional layer can be provided on an outermost layer of the separator.

For example, the separator further includes an adhesive layer separately from the above-described porous substrate and the above-described porous layer. In the present specification, the adhesive layer means a porous layer having adhesiveness. The adhesive layer can be provided on a surface of the separator which surface is in contact with the electrode. Examples of a component that is contained in the adhesive layer and that contributes to adhesiveness include an acrylic resin and PVdF.

### [2. Method for Producing Separator]

A coating solution obtained by dissolving or dispersing a resin in a solvent can be used to form the porous layer on the porous substrate so as to produce the separator. Note that the solvent can be described as being a dispersion medium in which a resin is dispersed. Examples of the resin include the above-listed nitrogen-containing aromatic resins and the above-listed resins other than the nitrogen-containing aromatic resins. Examples of a method for forming the coating solution include a mechanical stirring method, an ultrasonic dispersion method, a high-pressure dispersion method, and a media dispersion method.

The separator can be formed by, for example, (i) a method of applying the coating solution directly to a surface of a porous substrate and then removing the solvent, (ii) a method of applying the coating solution to an appropriate support, subsequently removing the solvent so as to form a porous layer, pressure-bonding the porous layer to the porous substrate, and peeling the support off, (iii) a method of applying the coating solution to a surface of an appropriate support, pressure-bonding the porous substrate to that surface, peeling the support off, and then removing the solvent, or (iv) a method of carrying out dip coating by immersing the porous substrate into the coating solution, and then removing the solvent.

The solvent preferably (i) does not have an adverse effect on the porous substrate, (ii) allows the resin to be uniformly and stably dissolved in the solvent, and (iii) allows the filler to be uniformly and stably dispersed in the solvent. Examples of the solvent include N-methyl-2-pyrrolidone (NMP), N,N-dimethylacetamide, N, N-dimethylformamide, acetone, and water.

The coating solution may contain a filler. As necessary, the coating solution may contain, as a component(s) other than the resin and the filler, for example, a disperser, a plasticizer, a surfactant, and/or a pH adjuster.

The coating solution can be applied to the porous substrate by a conventionally known method. Specific examples of such a method include a gravure coater method, a dip coater method, a bar coater method, and a die coater method.

In a case where the coating solution contains an aramid resin, the aramid resin can be deposited by applying moisture to a surface to which the coating solution is applied. The porous layer may be formed in this way. A specific method of applying moisture to the surface to which the coating solution is applied is exemplified by, but not particularly limited to, a method of exposing the surface to a high-humidity atmosphere, a method of spraying water with use of a spray or the like, and a method of blowing water vapor via a nozzle or the like.

A method for producing the porous substrate is not particularly limited. For example, a polyolefin resin composition in sheet form is produced by kneading a polyolefin-based resin together with a pore forming agent such as an inorganic bulking agent or a plasticizer, and optionally with another agent(s) such as an antioxidant, and then extruding the kneaded substances. The pore forming agent is then removed from the polyolefin resin composition in sheet form with use of a suitable solvent. Thereafter, the porous substrate can be produced by stretching the polyolefin-based resin composition from which the pore forming agent has been removed.

The inorganic bulking agent is exemplified by, but not particularly limited to, an inorganic filler, specific examples of which include calcium carbonate. The plasticizer is exemplified by, but not particularly limited to, a low molecular weight hydrocarbon such as liquid paraffin.

For example, satisfying the following condition (i) makes it possible to produce a separator in which the recovery rate product is controlled so as to be in a range of not less than 850%².
(i) As the coating solution, a coating solution that has a low filler content or that contains no filler is used.

In a case where the condition (i) is satisfied, a porous layer that contains no filler or that has a low filler content, that is, a porous layer that contains a large amount of resin, is obtained. Here, the porous layer includes a network structure that is composed of fibers which are made of a resin. In the porous layer, the network structure is maintained with respect to external force. Thus, the shape of the porous layer is retained, or, a force for recovering its original shape acts in a case where the shape of the porous layer is altered. As a result, plastic deformation is prevented, or the degree of plastic deformation is decreased. Further, in a case where the porous layer contains a filler, the network structure is broken by the filler which becomes embedded in the resin. As a result, the network structure is less likely to be maintained when subjected to external force. Therefore, in the case of the porous layer that has a high filler content, it is considered that the network structure is collapsed against external force, a porous structure of the porous layer is more likely to change in an irreversible manner, and the degree of plastic deformation thus increases. In contrast, in a porous layer that contains no filler or that has a low filler content, the breakage of the network structure does not exist, or the breakage of the network structure is small. Thus, the porous layer that contains no filler or that has a low filler content is more likely to maintain the network structure when subjected to external force. Therefore, in the case of the porous layer that contains no filler or that has a low filler content, it is considered that the porous layer is deformed with the network structure maintained with respect to external force, and the degree of plastic deformation thus decreases.

Further, satisfying, in addition to the condition (i), at least one of the following conditions (ii) to (iv) makes it possible to more suitably control the recovery rate product to a value as high as not less than 850%².
(ii) As the resin in the coating solution, a resin including two or more resins having different deposition properties or containing two or more components having different deposition properties is used;
(iii) The solvent in the coating solution is removed, and a deposition time for depositing a porous layer is adjusted to a time that is equal to or longer than a certain length of time.
(iv) As a deposition method, a humidity in a deposition tank is changed over time.

As a mechanism by which satisfying the condition (ii), in addition to satisfying the condition (i), makes it possible to more suitably control the recovery rate product to a value as high as not less than 850%², the following mechanism can be considered, though speculative. In a case where the condition (ii) is satisfied, in the process of deposition, a resin or component (first resin or first component) that has a high deposition property and that is easily deposited is deposited earlier, whereas a resin or component (second resin or second component) that has a low deposition property and that is not easily deposited is deposited later. Due to compatibility between the first resin or the first component and a solvent, the second resin or the second component is deposited near the first resin or the first component that has been deposited earlier. Since the resins or components are thus deposited in an unevenly distributed manner, the resins can sufficiently form a network structure that is more likely to be maintained even when subjected to external force. Thus, it is considered that satisfying the condition (ii) makes it possible to control the recovery rate product to a value as high as not less than 850%².

Note here that the two or more resins having different deposition properties can be, for example, two or more resins having different degrees of solubility in a solvent in the coating solution. Further, a deposition property of a resin can vary depending on the molecular weight of the resin. Therefore, a resin containing two or more components having different deposition properties can be, for example, a resin having a wide molecular weight distribution. That is, using at least one resin having a wide molecular weight distribution, in addition to satisfying the condition (i), makes it possible to suitably produce a separator in which the recovery rate product is controlled to a value as high as not less than 850%².

Further, satisfying the condition (iii), in addition to satisfying the condition (i), adjusts the deposition time to a time that is equal to or longer than a certain length of time and thus lengthens a time that elapses from deposition of the resin which is easily deposited to deposition of the resin which is not easily deposited. As a result, it is possible to sufficiently form fibers that are made of a resin which makes up a porous layer and a network structure that is composed of the fibers. Therefore, satisfying the condition (iii), in addition to satisfying the condition (i), adjusts the first recovery rate and the second recovery rate to high values and thus makes it possible to control the recovery rate product to a value as high as not less than 850%². Note that, specifically, the deposition time only needs to be adjusted to preferably not less than 5 seconds, and more preferably not less than 10 seconds.

Furthermore, it is considered that satisfying the condition (iv), in addition to satisfying the condition (i), changes a humidity in a deposition tank over time and thus changes a deposition speed in an early stage and a late stage, and a mechanism similar to the mechanism provided in a case where the condition (ii) is satisfied makes it possible to more suitably produce a separator in which the recovery rate product is controlled to a value as high as not less than 850%².

As described above, it is considered that the porous layer obtained by satisfying the condition (i) is less likely to be subjected to plastic deformation. Thus, it is considered that the porous layer easily recovers its shape when subjected to deformation by external force, the first recovery rate and the second recovery rate become high, and, as a result, it is possible to control the recovery rate product to a value as high as not less than 850%². Further, it is considered that satisfying, in addition to the condition (i), at least one of the conditions (ii) to (iv) makes the first recovery rate and the second recovery rate higher, and, as a result, makes it possible to more suitably control the recovery rate product to a value as high as not less than 850%².

### [3. Material, Electrochemical Device]

A material in accordance with an embodiment of the present invention includes a positive electrode, a separator described above, and a negative electrode, the positive electrode, the separator, and the negative electrode being arranged in this order. An electrochemical device in accordance with an embodiment of the present invention includes a separator described above.

Examples of the electrochemical device include a secondary battery and a capacitor. Examples of the secondary battery include a nonaqueous electrolyte secondary battery such as a lithium ion secondary battery. Examples of the capacitor include an electric double layer capacitor. A nonaqueous electrolyte secondary battery is not particularly limited in shape and can have any shape such as the shape of a thin plate (sheet), a disk, a cylinder, or a prism such as a cuboid.

For example, the material can be formed by arranging the positive electrode, the above-described separator, and the negative electrode in this order. The porous layer can be provided between the porous substrate and at least one of the positive electrode and the negative electrode. The material is then placed in a container that serves as a housing for the electrochemical device. In this manner, it is possible to produce the electrochemical device. In the case of a nonaqueous electrolyte secondary battery, the container is filled with a nonaqueous electrolyte (described later) and then hermetically sealed while pressure is reduced in the container.

### <Positive Electrode>

The positive electrode is not limited to any particular one, provided that the positive electrode is one that is generally used as a positive electrode of an electrochemical device. Examples of the positive electrode include a positive electrode sheet having a structure in which an active material layer containing a positive electrode active material and a binding agent is formed on a positive electrode current collector. The active material layer may further contain an electrically conductive agent.

Examples of the positive electrode active material include materials each capable of being doped with and dedoped of metal ions such as lithium ions or sodium ions. Specific examples of the materials include a lithium-containing complex metal oxide containing lithium (Li) and at least one transition metal selected from the group consisting of V, Cr, Mn, Fe, Co, Ni, Cu, and Al. Examples of such a lithium-containing complex metal oxide include LiCoO₂, LiNiO₂, LiMn₂O₄, Li₂MnO₃, LiNiₓMn_{y}Co_{1-x-y}O₂[0<x+y<1], LiNiₓCo_{y}Al_{1-x-y}O₂[0<x+y<1], LiCr_{0.5}Mn_{0.5}O₂, LiFePO₄, Li₂FeP₂O₇, LiMnPO₄, LiFeBO₃, Li₃V₂(PO₄)₃, Li₂CuO₂, Li₂FeSiO₄, and Li₂MnSiO₄.

Examples of the electrically conductive agent include carbonaceous materials such as natural graphite, artificial graphite, cokes, carbon black (e.g., acetylene black), pyrolytic carbons, fibrous carbon materials, and fired products of and organic polymer compounds. Each of the above electrically conductive agents may be used alone. Alternatively, two or more of the above electrically conductive agents may be used in combination. A proportion of the electrically conductive agent in a positive electrode mix is preferably not less than 5 parts by mass and not more than 20 parts by mass with respect to 100 parts by mass of the positive electrode active material. The proportion can be reduced in a case where a fibrous carbon material such as graphitized carbon fiber or a carbon nanotube is used as the electrically conductive agent.

The binding agent can be a thermoplastic resin. Examples of the thermoplastic resin include fluorine-based resins such as PVdF, polytetrafluoroethylene (PTFE), a tetrafluoroethylene-hexafluoropropylene-vinylidene fluoride-based copolymer, a hexafluoropropylene-vinylidene fluoride-based copolymer, and a tetrafluoroethylene-perfluorovinyl ether-based copolymer, acrylic resins, styrene butadiene rubber, polyimide resins, and polyolefin resins. Note that the binding agent serves also as a thickener. It is possible to use a mixture of two or more of these thermoplastic resins. A positive electrode mix that has both great adhesion to the positive electrode current collector and a high bonding strength inside the positive electrode mix can be obtained by using a fluororesin and a polyolefin resin as a binder to adjust a ratio of the fluororesin to all the positive electrode mix to not less than 1% by mass and not more than 10% by mass, and adjust a ratio of the polyolefin resin to all the positive electrode mix to not less than 0.1% by mass and not more than 2% by mass.

Examples of the positive electrode current collector include electric conductors such as Al, Ni, and stainless steel. Among these electric conductors, Al is more preferable because Al is easily processed into a thin film and is inexpensive.

Examples of a method for producing the positive electrode sheet include: a method in which the positive electrode active material, the electrically conductive agent, and the binding agent (positive electrode mix) are pressure-molded on the positive electrode current collector; and a method in which (i) the positive electrode mix is formed into a paste with use of an appropriate organic solvent, (ii) the positive electrode current collector is coated with the paste, and (iii) the paste is dried and then pressure is applied so that the paste is firmly fixed to the positive electrode current collector.

Examples of an organic solvent that can be used in the above method include: amine-based solvents such as N, N-dimethylaminopropylamine and diethylenetriamine; ether-based solvents such as tetrahydrofuran; ketone-based solvents such as methyl ethyl ketone; ester-based solvents such as methyl acetate; and amide-based solvents such as dimethylacetamide and NMP.

Examples of a method of applying a paste of the positive electrode mix to the positive electrode current collector include a slit-die coating method, a screen coating method, a curtain coating method, a knife coating method, a gravure coating method, and an electrostatic spray method.

### <Negative Electrode>

The negative electrode is not limited to any particular one, provided that the negative electrode is one that is generally used as a negative electrode of an electrochemical device. Examples of the negative electrode include a negative electrode sheet having a structure in which an active material layer containing a negative electrode active material and a binding agent is formed on a negative electrode current collector. The active material layer may further contain an electrically conductive agent.

Examples of the negative electrode active material include materials each capable of being doped with and dedoped of metal ions such as lithium ions or sodium ions. Examples of the materials include materials which are carbonaceous materials, chalcogen compounds (such as oxides and sulfides), nitrides, metals, and alloys and each of which is capable of being doped with and dedoped of lithium ions at electric potentials lower than that of the positive electrode. Examples of the carbonaceous materials include natural graphite, artificial graphite, cokes, carbon black, and pyrolytic carbons.

Examples of the oxides that can be used as the negative electrode active material include: oxides of silicon which are represented by a formula SiOₓ (where x is a positive real number), such as SiO₂ and SiO; oxides of titanium which are represented by a formula TiOₓ (where x is a positive real number), such as TiO₂ and TiO; oxides of vanadium which are represented by a formula VOₓ (where x is a positive real number), such as V₂O₅ and VO₂; oxides of iron which are represented by a formula FeOₓ (where x is a positive real number), such as Fe₃O₄, Fe₂O₃, and FeO; oxides of tin which are represented by a formula SnOₓ (where x is a positive real number), such as SnO₂ and SnO; oxides of tungsten which are represented by a general formula WOₓ (where x is a positive real number), such as WO₃ and WO₂; and complex metal oxides each of which contains lithium and titanium or vanadium, such as Li₄Ti₅O₁₂ and LiVO₂.

Examples of the sulfides that can be used as the negative electrode active material include: sulfides of titanium which are represented by a formula TiSₓ (where x is a positive real number), such as Ti₂S₃, TiS₂, and TiS; sulfides of vanadium which are represented by a formula VSₓ (where x is a positive real number), such as V₃S₄, VS₂, and VS; sulfides of iron which are represented by a formula FeSₓ (where x is a positive real number), such as Fe₃S₄, FeS₂, and FeS; sulfides of molybdenum which are represented by a formula MoSₓ (where x is a positive real number), such as Mo₂S₃ and MoS₂; sulfides of tin which are represented by a formula SnSₓ (where x is a positive real number), such as SnS₂ and SnS; sulfides of tungsten which are represented by a formula WSₓ (where x is a positive real number), such as WS₂; sulfides of antimony which are represented by a formula SbSₓ (where x is a positive real number), such as Sb₂S₃; and sulfides of selenium which are represented by a formula SeSₓ (where x is a positive real number), such as SesS₃, SeS₂, and SeS.

Examples of the nitrides that can be used as the negative electrode active material include lithium-containing nitrides such as Li₃N and Li₃₋ₓAₓN (where A is one or both of Ni and Co, and 0<x<3 is satisfied).

Each of these carbonaceous materials, oxides, sulfides, and nitrides may be used alone. Alternatively, two or more of these carbonaceous materials, oxides, sulfides, and nitrides may be used in combination. These carbonaceous materials, oxides, sulfides, and nitrides may be each crystalline or amorphous.

Examples of the metals that can be used as the negative electrode active material include lithium metals, silicon metals, and tin metals.

Examples of the alloys that can be used as the negative electrode active material include lithium alloys such as Li—Al, Li—Ni, Li—Si, Li—Sn, and Li—Sn—Ni; silicon alloys such as Si—Zn; tin alloys such as Sn—Mn, Sn—Co, Sn—Ni, Sn—Cu, and Sn—La; and alloys such as Cu₂Sb and La₃Ni₂Sn₇.

These metals and alloys are each mainly solely used as an electrode after being processed into, for example, foil form. Among the above-listed negative electrode active materials, a carbonaceous material that contains, as a main component, graphite such as natural graphite or artificial graphite is preferably used. This is because such a carbonaceous material hardly changes in electric potential of a negative electrode (has good potential evenness) from an uncharged state to a fully charged state during charging, has a low average discharge potential, and has a high capacity maintenance rate (has a good cycle characteristic) when charging and discharging are repeatedly carried out. The shape of the carbonaceous material may be, for example, any of the following: a flake shape like natural graphite; a spherical shape like mesocarbon microbeads; a fibrous shape like graphitized carbon fiber; an aggregate of fine powders; and the like.

Examples of the negative electrode current collector include Cu, Ni, and stainless steel. Among these materials, Cu is more preferable because Cu is not easily alloyed with lithium and is easily processed into a thin film.

Examples of a method for producing the negative electrode sheet include: a method in which the negative electrode active material is pressure-molded on the negative electrode current collector; and a method in which (i) the negative electrode active material is formed into a paste with use of an appropriate organic solvent, (ii) the negative electrode current collector is coated with the paste, and (iii) the paste is dried and then pressure is applied so that the paste is firmly fixed to the negative electrode current collector. The paste preferably contains any of the above-listed electrically conductive agents and any of the above-listed binding agents.

The negative electrode sheet may contain a binder, as necessary. The binder can be, for example, a thermoplastic resin, specific examples of which include PVdF, thermoplastic polyimides, carboxymethyl cellulose, and polyolefin resins.

### <Nonaqueous Electrolyte>

A nonaqueous electrolyte is not limited to any particular one, provided that the nonaqueous electrolyte is one that is generally used for an electrochemical device, e.g., a nonaqueous electrolyte secondary battery. The nonaqueous electrolyte can be, for example, a nonaqueous electrolyte containing an organic solvent and a lithium salt dissolved in the organic solvent. Examples of the lithium salt include LiClO₄, LiPF₆, LiAsF₆, LiSbF₆, LiBF₄, LiCF₃SO₃, LiN(CF₃SO₂)₂, LiC(CF₃SO₂)₃, LiN(SO₂C₂F₅)₂, LiN(SO₂CF₃)(COCF₃), Li(C₄F₉SO₃), Li₂B₁₀Cl₁₀, LiBOB (where BOB refers to bis(oxalato)borate), LiFSI (where FSI refers to bis(fluorosulfonyl)imide), lower aliphatic carboxylic acid lithium salt, and LiAlCl₄. Each of the above lithium salts may be used alone. Alternatively, two or more of the above lithium salts may be used in combination. Among these electrolytes, it is preferable to use at least one fluorine-containing lithium salt selected from the group consisting of LiPF₆, LiAsF₆, LiSbF₆, LiBF₄, LiCF₃SO₃, LiN(SO₂CF₃)₂, and LiC(SO₂CF₃)₃.

Examples of the organic solvent include: carbonates such as propylene carbonate, ethylene carbonate, dimethyl carbonate, diethyl carbonate, ethyl methyl carbonate, 4-trifluoromethyl-1,3-dioxolane-2-on, and 1,2-di(methoxy carbonyloxy)ethane; ethers such as 1,2-dimethoxyethane, 1,3-dimethoxypropane, pentafluoropropyl methylether, 2,2,3,3-tetrafluoropropyl difluoromethylether, tetrahydrofuran, and 2-methyl tetrahydrofuran; esters such as methyl formate, methyl acetate, and γ-butyrolactone; nitriles such as acetonitrile and butyronitrile; amides such as N, N-dimethylformamide and N, N-dimethylacetamide; carbamates such as 3-methyl-2-oxazolidone; sulfur-containing compounds such as sulfolane, dimethyl sulfoxide, and 1,3-propane sultone; and solvents each prepared by further introducing a fluoro group into any of these organic solvents (i.e., solvents each prepared by substituting one or more hydrogen atoms of any of these organic solvents with one or more respective fluorine atoms). Each of the above organic solvents may be used alone. Alternatively, two or more of the above organic solvents may be used in combination. In particular, a mixed solvent containing a carbonate is preferable, and a mixed solvent containing a cyclic carbonate and an acyclic carbonate, and a mixed solvent containing a cyclic carbonate and an ether are more preferable. The mixed solvent containing a cyclic carbonate and an acyclic carbonate is preferably a mixed solvent containing ethylene carbonate, dimethyl carbonate, and ethyl methyl carbonate. The electrolyte that contains such a mixed solvent has many advantages of having a wide operating temperature range, being less prone to deterioration even when subjected to charging and discharging at a high current rate, being less prone to deterioration even when used for a long period of time, and being less prone to decomposition even when the negative electrode active material is a graphite material such as natural graphite or artificial graphite.

The present invention is not limited to the embodiments, but can be altered by a skilled person in the art within the scope of the claims. The present invention also encompasses, in its technical scope, any embodiment derived by combining technical means disclosed in differing embodiments.

An embodiment of the present invention may include the following features.
<1> A separator for an electrochemical device, including a polyolefin porous substrate and a porous layer formed on the polyolefin porous substrate, wherein
   in a case where a cycle consisting of applying a pressure of 70 MPa to a surface of the separator for 60 seconds, carrying out unloading, and then letting the separator stand for 60 seconds is repeated twice, a product of a recovery rate [%] of the separator with respect to a compression amount in a first cycle and a recovery rate [%] of the separator with respect to a compression amount in a second cycle is not less than 850%².
<2> The separator described in <1>, wherein the recovery rate of the separator with respect to the compression amount in the second cycle is not less than 76%.
<3> The separator described in <1> or <2>, wherein the recovery rate of the separator with respect to the compression amount in the first cycle is not less than 10%.
<4> The separator described in any one of <1> to <3>, wherein the porous layer contains an aramid resin.
<5> The separator described in any one of <1> to <4>, further including an adhesive layer separately from the polyolefin porous substrate and the porous layer.
<6>A material including a positive electrode, a separator described in any one of <1> to <5>, and a negative electrode, the positive electrode, the separator, and the negative electrode being arranged in this order.
<7> An electrochemical device including a separator described in any one of <1> to <5>.
<8> The electrochemical device described in <7>, wherein the electrochemical device is a secondary battery or a capacitor.

### EXAMPLES

The following description will discuss an example of the present invention.

### [Measurement and Evaluation of Physical Properties]

Physical properties of separators disclosed in Examples and Comparative Examples were measured and evaluated by the following method.

### <Thickness>

The thickness of a separator was measured with use of a high-accuracy digital measuring instrument (manufactured by Mitutoyo Corporation). Specifically, each of the separators was cut into a square piece with an 8 cm side, and measurement was carried out at five points in the square piece. The thickness of the separator before compression was determined from an average value of measurements obtained at the five points.

Further, in the later-described calculation of the first compression amount, the first recovery amount, the second compression amount, and the second recovery amount, the amount of change in thickness of the separator that occurs when compression or unloading is carried out was measured at a portion, as a portion to be measured, where the flat indenter was pressed into the surface of the separator.

### <First Compression Amount, First Recovery Rate, Second Compression Amount, Second Recovery Rate, Recovery Rate Product, First Compressibility, and Second Compressibility>

(Measurement of Thickness Before Compression, Contact Start Point of Contract Between Indenter and Separator, Position of Indenter after First Compression, Position of Indenter after First Recovery, Position of Indenter after Second Compression, and Position of Indenter after Second Recovery)

The thickness of the separator before compression, a position of the indenter after first compression, a position of the indenter after first recovery, a position of the indenter after second compression, and a position of the indenter after second recovery were measured through the following procedure of steps 1 to 7.
Step 1. The thickness of the separator before compression was measured by the above-described method.
Step 2. A 1.5 cm square piece was cut out from the separator. The piece thus cut out of the separator, as a sample, was brought into close contact with a sample stage.
Step 3. A microcompression testing machine (MCT-510, SHIMADZU CORPORATION) was used to press, into the surface of the sample, a diamond flat indenter having a diameter of 50 μm. The flat indenter was pressed at a rate of 1.0 mN/s. The indenter was pressed into the surface of the sample until a time point when a load applied to the surface of the sample reached 138 mN (70 MPa). At this time, a position at which the load started increasing was regarded as a contact start point Z0 of contact between the indenter and the separator.
Step 4. For 60 seconds immediately after the load applied to the surface of the sample reached 70 MPa, the position of the flat indenter was fixed (held) as it was in a state in which the flat indenter was pressed into the surface of the sample. The position of the indenter at this time was regarded as an indenter position Z1 after first compression.
Step 5. The flat indenter was lifted from the surface of the sample until a time point when the load applied to the surface of the sample reached 1 mN (≈0 MPa).
Step 6. For 60 seconds immediately after the load applied to the surface of the sample reached 1 mN (≈0 MPa), the flat indenter was fixed (held) as it was in a state in which the flat indenter was lifted from the surface of the sample. The position of the indenter at this time was regarded as an indenter position Z2 after first recovery.
Step 7. The sample having been subjected to the operation in step 6 was subjected to operations that are similar to the operations in steps 3 to 6. Here, an indenter position at the time when the sample was subjected to an operation that is similar to the operation in step 4 was regarded as an indenter position Z3 after second compression. Further, an indenter position at the time when the sample was subjected to an operation that is similar to the operation in step 6 was regarded as an indenter position Z4 after second recovery.

### (Calculation of First Compression Amount, First Recovery Rate, Second Compression Amount, Second Recovery Rate, Recovery Rate Product, First Compressibility, and Second Compressibility)

The first compression amount was calculated in accordance with the following formula (4):

$$First compression amount = indenter position Z 1 after first compression - contact start point Z 0 \qquad ( 4 )$$

The first recovery amount was calculated in accordance with the following formula (5):

$$First recovery amount = indenter position Z 1 after first compression - indenter position Z 2 after first recovery \qquad ( 5 )$$

The second compression amount was calculated in accordance with the following formula (6):

$$Second compression amount = indenter position Z 3 after second compression - indenter position Z 2 after first recovery \qquad ( 6 )$$

The second recovery amount was calculated in accordance with the following formula (7):

$$Second recovery amount = indenter position Z 3 after second compression - indenter position Z 4 after second recovery \qquad ( 7 )$$

With use of the first compression amount and the first recovery amount, the first recovery rate [%] of the separator was calculated in accordance with the following formula (1):

$$First recovery rate [ \% ] = ( first recovery amount [ μm ] / first compression amount [ μm ] ) \times 100 \qquad ( 1 )$$

With use of the second compression amount and the second recovery amount, the second recovery rate [%] of the separator was calculated in accordance with the following formula (2):

$$Second recovery rate [ \% ] = ( second recovery amount [ μm ] / second compression amount [ μm ] ) \times 100 \qquad ( 2 )$$

With use of the first recovery rate [%] and the second recovery rate [%], the recovery rate product of the separator was calculated in accordance with the following formula (3):

$$Recovery rate product [ {\%}^{2} ] = ( first recovery rate [ \% ] ) \times ( second recovery rate [ \% ] ) \qquad ( 3 )$$

With use of the thickness of the separator before compression and the first compression amount, the first compressibility of the separator was calculated in accordance with the following formula (8):

$$First compressibility [ \% ] = ( first compression amount [ μm ] / thickness before compression [ μm ] ) \times 100 \qquad ( 8 )$$

With use of the thickness of the separator before compression, the first compression amount, the first recovery amount, and the second compression amount, the second compressibility of the separator was calculated in accordance with the following formula (9):

$$Second compressibility [ \% ] = ( second compression amount [ μm ] / ( thickness before compression [ μm ] - first compression amount [ μm ] + first recovery amount [ μm ] ) ) \times 100 \qquad ( 9 )$$

### <Cycle Characteristic>

### (Production of Nonaqueous Electrolyte Secondary Battery)

A test nonaqueous electrolyte secondary battery in which a separator was incorporated was produced as an electrochemical device through the following procedure.
Step 1. A positive electrode having a thickness of 49.9 μm, a density of 2.97 g/cm³, and a void volume of 24.4 μL was prepared. The positive electrode has a structure in which a positive electrode active material layer is formed on a positive electrode current collector. The positive electrode active material layer was made up of LiNi_{0.78}Co_{0.19}Al_{0.03}O₂, an electrically conductive material, and polyvinylidene fluoride at a weight ratio of 92:4:4. Further, the positive electrode current collector was an electric conductor made of aluminum, and the electrically conductive material was acetylene black.
Step 2. A negative electrode having a thickness of 71.2 μm, a density of 1.45 g/cm³, and a void volume of 41.3 μL was prepared. The negative electrode has a structure in which a negative electrode active material layer is formed on a negative electrode current collector. The negative electrode active material layer was made up of artificial graphite, styrene butadiene rubber, and carboxymethyl cellulose at a weight ratio of 96.5:2.0:1.5. Further, the negative electrode current collector was an electric conductor made of copper.
Step 3. The negative electrode prepared in step 2, the separator, and the positive electrode prepared in step 1 were formed on top of each other in the order of the negative electrode, the separator, and the positive electrode so that a material for a nonaqueous electrolyte secondary battery was produced. In so doing, the negative electrode and the separator were formed on top of each other in such a manner that the negative electrode active material layer of the negative electrode and a polyolefin substrate-side surface of the separator faced each other. Further, the positive electrode and the separator were formed on top of each other in such a manner that the positive electrode active material layer of the positive electrode and a porous layer-side surface of the separator faced each other.
Step 4. The material for a nonaqueous electrolyte secondary battery produced in step 3 was stored in a bag including an aluminum layer and a heat-sealing layer that were formed on top of each other, and a nonaqueous electrolyte was then injected into the bag. The amount of the nonaqueous electrolyte injected was 230 μL. Used as the nonaqueous electrolyte was a nonaqueous electrolyte that was prepared by dissolving vinylene carbonate and LiPF₆ in a mixed solvent so that the concentration of vinylene carbonate became 1% by weight, and the concentration of LiPF₆ became 1 mol/L. Used as the mixed solvent was a mixed solvent that was obtained by mixing ethylene carbonate, ethyl methyl carbonate, and diethyl carbonate at a ratio (volume ratio) of 3:5:2.
Step 5. The bag, produced in step 4, in which the material for a nonaqueous electrolyte secondary battery was stored and into which the nonaqueous electrolyte was injected was heat-sealed while pressure inside the bag was reduced. In this way, the test nonaqueous electrolyte secondary battery was produced.

### (Measurement of Capacity Maintenance Rate)

The discharge capacity of the produced test nonaqueous electrolyte secondary battery was measured through the following procedure.
Step 1. The test nonaqueous electrolyte secondary battery was subjected to one cycle of initial charge and discharge at a temperature of 25° C., in a voltage range of 2.7 V to 4.2 V, and at a current value of 0.1 C (charge) or 0.2 C (discharge). Note here that 1 C is a current value at which a battery rated capacity derived from a one-hour rate discharge capacity is discharged in one hour.
Step 2. The test nonaqueous electrolyte secondary battery having been subjected to the initial charge and discharge in step 1 was subjected to 10 cycles of charge and discharge at a temperature of 25° C., in a voltage range of 2.7 V to 4.2 V, at a current value of 1 C (charge) or 5 C (discharge), so that the test nonaqueous electrolyte secondary battery was aged.
Step 3. The test nonaqueous electrolyte secondary battery having been aged in step 2 was subjected to one cycle of charge and discharge at a temperature of 25° C., in a voltage range of 2.7 V to 4.2 V, and at a current value of 0.2 C (charge) or 0.2 C (discharge). Further, the discharge capacity in the one cycle of charge and discharge was measured. The measured discharge capacity was regarded as an initial capacity (mAh).
Step 4. The test nonaqueous electrolyte secondary battery having been subjected to the one cycle of charge and discharge in step 3 was subjected to 200 cycles of charge and discharge at a temperature of 45° C., in a voltage range of 2.7 V to 4.2 V, and at a current value of 1 C (charge) or 5 C (discharge). The discharge capacity in the 200th cycle of charge and discharge among the 200 cycles of charge and discharge was measured. The measured discharge capacity in the 200th cycle of charge and discharge was regarded as a discharge capacity (mAh) after 200 cycles. A value obtained by dividing the discharge capacity (mAh) after 200 cycles by the initial capacity (mAh) was regarded as a capacity maintenance rate after 200 cycles.

### Synthesis Example 1: Synthesis of Resin A

The resin A (poly(4,4′-diphenylsulfonyl terephthalamide)) was synthesized by the following procedure.
1. A 0.5-L separable flask having a stirring blade, a thermometer, a nitrogen incurrent canal, and a powder addition port was sufficiently dried.
2. 408.6 g of NMP was introduced into the flask. Further, 31.4 g of calcium chloride (having been dried at 200° C. for 2 hours) was added, and a resulting mixture was heated to 100° C.
3. After the calcium chloride completely dissolved, 31.97 g of 4,4′-diaminodiphenylsulfone was added at 100° C., and then a resulting mixture was completely dissolved.
4. A resulting solution was cooled to room temperature. While the temperature of the solution was maintained at 25±2° C., 25.88 g in total of terephthalic acid dichloride was added in 3 separate portions.
5. While the temperature of a resulting solution was maintained at 25±2° C., the solution was matured for 1 hour to obtain the solution that contained the resin A.

### Synthesis Example 2: Synthesis of Resin B

The resin B (poly(paraphenylene terephthalamide)) was synthesized by the following procedure.
1. A 0.5-L separable flask having a stirring blade, a thermometer, a nitrogen incurrent canal, and a powder addition port was sufficiently dried.
2. 408.6 g of NMP was introduced into the flask. Further, 31.4 g of calcium chloride (having been dried at 200° C. for 2 hours) was added, and a resulting mixture was heated to 100° C.
3. After the calcium chloride completely dissolved, the temperature of a resulting solution was returned to room temperature. Subsequently, 13.20 g of paraphenylenediamine was added and completely dissolved.
4. While the temperature of a resulting solution was maintained at 25±2° C., 24.24 g in total of terephthalic acid dichloride was added in 3 separate portions.
5. While the temperature of a resulting solution was maintained at 25±2° C., the solution was matured for 1 hour to obtain the solution that contained the resin B.

### Example 1

A separator in which a porous layer containing the resin A, the resin B, and alumina at a weight ratio of 50:50:5 was formed on a porous substrate was produced. Specifically, a mixture (1) was obtained by mixing the solutions obtained in Synthesis Examples 1 and 2 so that the weight ratio between the resin A and the resin B was 50:50. To 500 g of the mixture (1) thus obtained, 11.68 g of calcium carbonate was added. A resulting solution was stirred for 10 minutes so as to be neutralized. Thus, a neutralized solution (1) was obtained. Subsequently, alumina (average particle diameter: 13 nm) was added to the neutralized solution (1) so that the weight ratio among the resin A, the resin B, and the alumina was 50:50:5, and a resulting solution was further diluted with NMP and defoamed under reduced pressure to prepare a coating solution (1) in slurry form. The coating solution (1) had a solid content concentration of 4.5% by weight.

The coating solution (1) was applied to a polyethylene porous film (thickness: 10.3 μm, air permeability: 180 s/100 mL), which is a porous substrate, so that a porous layer (1) was deposited on the porous substrate under deposition conditions of 50° C. and a humidity of 70%. Note that a deposition time was set to 10 seconds. Thereafter, the polyethylene porous film and the porous layer (1) were washed with water and dried to obtain a laminated separator in which the porous layer (1) was formed on the porous substrate. The laminated separator thus obtained was regarded as a separator (1). The separator (1) had a thickness of 12.6 μm.

### Example 2

A separator including a porous layer that contained no alumina and that contained the resin A and the resin B at a weight ratio of 50:50 was produced. Specifically, operations were carried out in the same manner as in Example 1 to obtain a laminated separator in which a porous layer (2) was formed on a porous substrate, except that alumina was not added to the neutralized solution (1). The laminated separator thus obtained was regarded as a separator (2). The separator (2) had a thickness of 13.0 μm.

### Example 3

A separator including a porous layer that contained no alumina and that contained the resin A and the resin B at a weight ratio of 70:30 was produced. Specifically, operations were carried out in the same manner as in Example 2 to obtain a laminated separator in which a porous layer (3) was formed on a porous substrate, except that the solutions obtained in Synthesis Examples 1 and 2 were mixed so that the weight ratio between the resin A and the resin B was 70:30. The laminated separator thus obtained was regarded as a separator (3). The separator (3) had a thickness of 13.4 μm.

### Comparative Example 1

A separator including a porous layer that contained the resin A, the resin B, and alumina at a weight ratio of 50:50:100 was produced. Specifically, operations were carried out in the same manner as in Example 1 to obtain a laminated separator in which a porous layer (4) was formed on a porous substrate, except that alumina was added to the neutralized solution (1) so that the weight ratio among the resin A, the resin B, and alumina was 50:50:100. The laminated separator thus obtained was regarded as a comparative separator (1). The comparative separator (1) had a thickness of 13.3 μm.

### [Results]

Tables 1 and 2 show production conditions in Examples and Comparative Examples, specifically, weight ratios of used raw materials and results of evaluation of the produced separators.

TABLE 1

| | | | | Evaluation result | | | | | |
|---|---|---|---|---|---|---|---|---|---|
| | | | | | | | | | Nonaqueous |
| | | | | | | | | | electrolyte |
| | | | | | | | | | secondary |
| | | | | | | | | | battery |
| | Production condition | | | Separator | | | | | Capacity |
| | Weight ratio of raw | | | First | Second | Recovery | | | maintenance |
| | material | | | recovery | recovery | rate | First | Second | rate after |
| | Resin | Resin | Filler | rate | rate | product | compressibility | compressibility | 200 cycles |
| | A | B | (alumina) | [%] | [%] | [%²] | [%] | [%] | [%] |
| Example 1 | 50 | 50 | 5 | 15.1 | 82.7 | 1246 | 46 | 12 | 65 |
| Example 2 | 50 | 50 | 0 | 11.8 | 77.4 | 917 | 47 | 11 | 62 |
| Example 3 | 70 | 30 | 0 | 14.8 | 78.5 | 1162 | 37 | 9 | 63 |
| Comparative | 50 | 50 | 100 | 11.4 | 74.6 | 847 | 43 | 9 | 60 |
| Example 1 | | | | | | | | | |

As shown in Table 1, the separators (1) to (3) each have a recovery rate product of not less than 850%². Thus, the separators (1) to (3) each fall under the separator in accordance with an embodiment of the present invention. In contrast, the comparative separator (1) has a recovery rate product of less than 850%², and thus does not fall under the separator in accordance with an embodiment of the present invention.

Further, nonaqueous electrolyte secondary batteries including respective ones of the separators (1) to (3) each have a high capacity maintenance rate after 200 cycles as compared to a nonaqueous electrolyte secondary battery including the comparative separator (1). Thus, it has been shown that cycle characteristics of the nonaqueous electrolyte secondary batteries including the respective ones of the separators (1) to (3), especially high-rate cycle characteristics of the nonaqueous electrolyte secondary batteries including the respective ones of the separators (1) to (3), are more excellent.

The above has proved that the separator in accordance with an embodiment of the present invention enables improvement of a cycle characteristic of an electrochemical device including the above-described separator, especially a high-rate cycle characteristic of an electrochemical device including the above-described separator.

### INDUSTRIAL APPLICABILITY

An aspect of the present invention is applicable to an electrochemical device.

1. A separator for an electrochemical device, comprising a polyolefin porous substrate and a porous layer formed on the polyolefin porous substrate, wherein
in a case where a cycle consisting of applying a pressure of 70 MPa to a surface of the separator for 60 seconds, carrying out unloading, and then letting the separator stand for 60 seconds is repeated twice, a product of a recovery rate [%] of the separator with respect to a compression amount in a first cycle and a recovery rate [%] of the separator with respect to a compression amount in a second cycle is not less than 850%².

2. The separator of claim 1, wherein the recovery rate of the separator with respect to the compression amount in the second cycle is not less than 76%.

3. The separator of claim 1, wherein the recovery rate of the separator with respect to the compression amount in the first cycle is not less than 10%.

4. The separator of claim 1, wherein the porous layer contains an aramid resin.

5. The separator of claim 1, further comprising an adhesive layer separately from the polyolefin porous substrate and the porous layer.

6. A material comprising a positive electrode, a separator recited in claim 1, and a negative electrode, the positive electrode, the separator, and the negative electrode being arranged in this order.

7. An electrochemical device comprising a separator recited in claim 1.

8. The electrochemical device of claim 7, wherein the electrochemical device is a secondary battery or a capacitor.
